(19) United States
(12) Patent Application Publication
(10) Pub. No.: US 2004/0077779 A1
(43) Pub. Date: Apr. 22, 2004

(54) Aqueous coating compositions

(75) Inventors: Markus A. Schafheutle, Graz (AT); Anton Arzt, Neutillmitsch (AT); Julius Burkl, Graz (AT); Martina Glettler, Graz (AT); Gerlinde Petritsch, Graz (AT); Joerg Wango, Wundschuh (AT)

Correspondence Address: CONNOLLY BOVE LODGE & HUTZ, LLP, P O BOX 2207, WILMINGTON, DE, 19899, US

(73) Assignee: Surface Specialties Germany GmbH & Co. KG

(21) Appl. No.: 10/684,204

(22) Filed: Oct. 10, 2003

(30) Foreign Application Priority Data
Oct. 22, 2002 (DE) DE 102 49 304.9

(51) Int. Cl. C08K 3/00

(52) U.S. Cl. 524/589

(57) ABSTRACT

Aqueous coating compositions comprising polycarbonate polyols A2 and a polyurethane chain-extended with compounds D which are at least difunctional with respect to isocyanates, said polyurethane comprising building blocks of hydroxy acids C and urethane groups derived from polyfunctional isocyanates B, wherein the polyurethane contains blocks derived from polyene polyols A1 and from polycarbonate polyols A2; a process for preparing them; and a method of use thereof for the preparation of “soft feel” coatings

### FIELD OF THE INVENTION

The invention relates to aqueous coating compositions.

### BACKGROUND OF THE INVENTION

Aqueous coating compositions based on polyurethanes can be prepared and formulated through an appropriate choice of the building blocks so that the hard substrates coated with them are soft to the touch (“soft-feel”).

Coating compositions of this kind are described in Austrian patent application A 1738/99 (corresponding to U.S. Pat. No. 6,414,079). The polyurethanes used are based in part on polyester polyols, which through exposure to light or through hydrolysis in conjunction with exposure to water, acids or alkalis may be degraded over a relatively long time and also at elevated temperatures. This adversely affects the mechanical properties of the coating and the protection of the surface of the substrate. Polyurethanes based on hydroxy-functional polyene polymers exhibit only a low level of adhesion to the substrates thus coated.

It is therefore an object of the invention to develop coating compositions which are based on polyurethanes and lead to coatings which are insensitive to light exposure and to hydrolysis, produce good adhesion on the substrates, and are soft to the touch: it ought to be possible to adjust the tactile properties anywhere between rubberlike and waxlike.

### SUMMARY OF THE INVENTION

This object is achieved by a coating composition comprising polycarbonate polyols and a polyurethane containing blocks derived from polyene polyols and from polycarbonate polyols.

The present invention accordingly provides an aqueous coating composition comprising polycarbonate polyols A2 and a polyurethane chain-extended with compounds D which are at least difunctional with respect to isocyanates, said polyurethane comprising building blocks of hydroxy acids C, especially aliphatic bishydroxyalkylcarboxylic acids, and urethane groups derived from polyfunctional isocyanates B and said polyurethane containing blocks derived from polyene polyols A1 and from polycarbonate polyols A2.

The present invention further provides a process for preparing such aqueous coating compositions by staged reaction, in which first of all a prepolymer is prepared from polyene polyol A1, hydroxy acid C, and polyfunctional isocyanate B and this prepolymer is mixed with polycarbonate polyol A2 and dispersed in water containing in dissolved form a chain extender D.

The present invention further provides for the use of the coating compositions of the invention for producing coatings on hard substrates, especially metals, plastics, wood, and mineral substrates, the tactile properties of the coated substrate being easily adjustable in accordance with the desired effect by varying the amounts of polyene polyol and polycarbonate diol.

### DETAILED DESCRIPTION OF THE PREFERRED EMBODIMENTS

The polyene polyols A1 are, in particular, telechelic; that is, they carry hydroxyl groups at the chain ends. Preference is given to polydienes having two reactive hydroxyl groups. They are prepared in particular by free-radically initiated polymerization of aliphatic linear, branched or cyclic compounds having at least two conjugated double bonds and 4 to 20 carbon atoms. As initiator, use is made of free-radical initiators which produce hydroxyl groups at the chain end, such as hydrogen peroxide, or azo compounds such as 2,2′-azobis(2-methyl-N-(2-hydroxyethyl)propionamide). Another way of producing the polyene polyols is by anionic polymerization, initiated for example with dilithium naphthalene. When the polymerization is terminated the end group can be selected by an appropriate choice of terminating agents. Suitable unsaturated hydrocarbons are, in particular, dienes, such as butadiene, isoprene, chloroprene, 1,3-pentadiene, and cyclopentadiene, which can also be copolymerized in a mixture. Particular preference is given to polybutadienes having 2 hydroxyl groups as end groups, especially to those having a number-average molar mass Mn of from about 1000 to 15 000 g/mol.

The polycarbonate polyols, especially polycarbonate diols, A2 are derived from aliphatic linear, branched or cyclic diols having 2 to 40 carbon atoms which are linked by way of carbonate groups (carbonic ester groups). They generally have number-average molar masses of from 700 to 2500 g/mol, and hydroxyl numbers of from 40 to 160 mg/g. The diols are preferably glycol, 1,2- and 1,3-dihydroxypropane, 1,4-dihydroxybutane, 1,6-dihydroxyhexane, neopentyl glycol, diethylene and triethylene glycol, and cyclohexanedimethanol, and mixtures of these diols can also be used. It is also possible as well to use small amounts of polyfunctional alcohols such as trimethylolpropane. Their mass fraction in the overall mass of the polyols is preferably up to 5%.

The mass ratio of the blocks derived from polyene polyols A1 to blocks derived from polycarbonate polyols A2 in the coating composition is preferably from 1:8 to 4:5, more preferably from 1:7 to 3:5, and in particular from 1:6 to 2:5.

The polyfunctional isocyanates B are aliphatic or aromatic compounds having (on average, where mixtures of two or more compounds are used) two or more than two isocyanate groups per molecule. The suitable aromatic diisocyanates include tolylene diisocyanate (technical-grade mixture of the 2,4- and 2,6-isomers) and diphenylmethane diisocyanate. Preference is given to linear, branched, and cyclic aliphatic isocyanates, especially difunctional isocyanates, having 2 to 15 carbon atoms in the (cyclo)aliphatic radical. Among the aromatic isocyanates it is also possible with preference to use those which carry isocyanate groups on a carbon atom having aliphatic character; an example thereof is tetramethylxylylene diisocyanate. Other preferred isocyanates are 1,6-diisocyanatohexane, 1,6-diisocyanato-3,3,5- and -3,5,5-trimethylhexane, 1,4-diisocyanatocyclohexane, isophorone diisocyanate, 2,2-bis(4-isocyanatocyclohexyl)propane, and the uretdione, allophonate and biuret derivatives thereof.

The hydroxy acids C are preferably dihydroxy carboxylic acids having 4 to 8 carbon atoms such as bishydroxymethylpropionic acid and bishydroxymethylacetic acid or tartaric acid. 2,2-Bishydroxymethylpropionic acid is particularly preferred. Further suitable examples include dihydroxy sulfonic acids such as N,N-bis(2-hydroxyethyl)-2-aminoethanesulfonic acid and N,N-bis(2-hydroxyethyl)-3-amino-2-hydroxypropanesulfonic acid. Instead of the hydroxy acids or in a mixture therewith it is also possible to use amines having at least two primary or secondary amino groups or mercaptans having at least two mercapto groups and in each case at least one acid group: examples are diaminocarboxylic acids such as ornithine or dimercaptosulfonic acids such as 2,3-dimercaptopropanesulfonic acid; examples of molecules having mixed isocyanate-reactive groups are serine (—OH and —NH₂) and cysteine (—SH and —NH₂).

The hydroxy acids C and/or the stated equivalent compounds are used preferably in amounts such that the acid number of the polyurethane is at least 15 mg/g, more preferably at least 20 mg/g, and in particular at least 25 mg/g. The acid number is based as usual on the mass of the solids in the dispersion, i.e., on the mass of the polyurethane. The acid number is defined in accordance with DIN 53 402 as the ratio of that mass m_{KOH} of potassium hydroxide that is required to neutralize a sample under analysis to the mass m_{B} of this sample (mass of the solids in the sample in the case of solutions or dispersions); its customary unit is “mg/g”.

The chain extenders D are compounds having at least two isocyanate-reactive hydrogen atoms which react more quickly with the isocyanate in aqueous solution or dispersion than does water. They include, in particular, amines having at least two primary or secondary or at least one primary and at least one secondary amino group, and also dimercaptans and amino mercaptans having one primary or secondary amino group. Preference is given to linear and branched aliphatic diamines having 2 to 9 carbon atoms such as ethylenediamine, 1,4-diaminobutane, 1,6-diaminohexane, 2,2,4- and 2,4,4-trimethyl-1,6-diaminohexane, and neopentanediamine. Likewise suitable are hydrazine or dihydrazides of aliphatic linear, branched or cyclic dicarboxylic acids.

The ratio of the amount of substance of the isocyanate-reactive groups of the chain extenders D to the amount of substance of the isocyanate groups in the prepolymers is preferably from 0.5:1 to 1.05:1, more preferably from 0.8:1 to 1:1.

A process for preparing the aqueous polyurethane dispersions of the invention comprises the steps of a) reacting a mixture of polyene polyol A1, hydroxy acid C, and a neutralizing agent for the latter in an organic solvent containing no groups which are reactive toward isocyanates with a polyfunctional isocyanate B to form an isocyanate-functional prepolymer, b) adding the polycarbonate diol A2 and mixing it in thoroughly, c) dispersing the at least partly reacted mixture in water containing in dissolved form a chain extender D, and d) removal of the organic solvent by destillation. To a small extent there is a reaction of the added polycarbonate polyol A2 with the isocyanate-functional prepolymer. Preferably between 1 and 20%, more preferably between 2 and 15%, and in particular from 3 to 10% of the polycarbonate polyol A2 are bonded chemically to the isocyanate-functional prepolymer by reaction with it.

In this process it is preferable for the isocyanate-functional prepolymer prepared in the first step to have a Staudinger index of at least 18 cm³/g, measured in chloroform at 20° C.; particular preference is given to a figure of at least 20 cm³/g, and in particular a figure of at least 21 cm³/g.

The aqueous coating compositions of the invention can be used for producing coatings on hard substrates such as metals, plastics, wood, concrete, and glass, and produce coatings whose tactile properties (sensation on contact) can be adjusted from waxlike to rubberlike in accordance with the mixing ratio of polyene polyol as soft component and polycarbonate diol as hard component. By adding crosslinking agents such as amino resins and preferably polyfunctional isocyanates, which where appropriate may have been hydrophilically modified, the coatings can be cured at elevated temperature or at room temperature. The aqueous dispersions can have the usual additions added to them, such as pigments, antifoams, antisettling agents, and thickeners. Surprisingly it is found that the polyurethane dispersions of the invention, especially when crosslinked with polyfunctional isocyanates, exhibit outstanding adhesion to all of the stated substrates.

The examples which follow illustrate the invention but without restricting it. The formerly so-called “intrinsic viscosity number”, called “Staudinger index” J_{q} according to DIN 1342, part 2.4, is the limiting value of the Staudinger function Jᵥ at decreasing concentration and shear stress, Jᵥ being the relative change in viscosity based on the mass concentration β_{B}=m_{B}/V of the dissolved substance B (with the mass m_{B} of the substance in the volume V of the solution); i.e., Jᵥ=(ηᵣ−1)/β_{B}. In this equation ηᵣ−1 denotes the relative change in viscosity, in accordance with ηᵣ−1=(η−η₅)/η₅. The relative viscosity ηᵣ is the ratio of the viscosity η of the solution under analysis to the viscosity ηₛ of the pure solvent. (The physical definition of the Staudinger index is that of a specific hydrodynamic volume of the solvated polymer coil at infinite dilution and in the state of rest.) The unit usually used for J is “cm³/g”; formerly often “dl/g”. The hydroxyl number is defined in accordance with DIN 53 240 as the ratio of that mass m_{KOH} of potassium hydroxide which has exactly the same number of hydroxyl groups as a sample under analysis to the mass m_{B} of that sample (mass of the solids in the sample in the case of solutions or dispersions); its customary unit is “mg/g”.

### EXAMPLES

### Example 1

302.3 g of polybutadiene diol (hydroxyl number about 45 to 50 mg/g, ®PolyBD-R45 HTLO from Cray Valley), 10.8 g of triethylamine and 17.9 g of dimethylolpropionic acid were dissolved in 340 g of methyl ethyl ketone at from 75 to 80° C. When a clear, homogeneous solution had been obtained, 89.9 g of isophorone diisocyanate were added. The reactor was sealed and the batch was stirred until the Staudinger index (“intrinsic viscosity number”) had reached a value of between 22 and 23 cm³/g. The internal pressure of the reactor rose to about 0.4 bar above the external pressure. When this Staudinger index had been reached, 107.7 g of polycarbonate diol (®Ravecarb 107, Enichem) were added and were stirred together with the prepolymer for 15 minutes. This mixture was subsequently dispersed with a solution of 19.6 g of adipic dihydrazide in 665.3 g of deionized water, in the course of which it underwent chain extension. The temperature fell to about 40° C. After 15 minutes of stirring the temperature was slowly raised to 75° C. Starting at about 45° C., an azeotrope of methyl ethyl ketone and water was distilled off. When most of the methyl ethyl ketone had been distilled off, distillation was continued under a slight subatmospheric pressure (100 to 400 mbar) with an increase in the temperature. After the methyl ethyl ketone had all been removed, deionized water was added to set a mass fraction of solids (nonvolatile fraction) of 50%. The product was a fine, solvent-free dispersion having a viscosity (23° C., 25 s⁻¹) of 930 mPa·s.

### Example 2

302.3 g of polybutadiene diol (hydroxyl number 45 to 50 mg/g, ®PolyBD-R45 HTLO from Cray Valley), 9.2 g of triethylamine and 17.9 g of dimethylolpropionic acid were dissolved in 340 g of methyl ethyl ketone at from 75 to 80° C. When a clear, homogeneous solution had been obtained, 89.9 g of isophorone diisocyanate were added. The reactor was sealed and the batch was stirred until the Staudinger index (“intrinsic viscosity number”) had reached a figure of between 22 and 23 cm³/g. The internal pressure of the reactor rose to about 0.4 bar above the external pressure. When this Staudinger index had been reached, 107.7 g of polycarbonate diol (®Ravecarb 107, Enichem) were added and the components were stirred together for 15 minutes. This mixture was dispersed with 607 g of deionized water and immediately thereafter was chain-extended with a solution of 6.8 g of ethylenediamine in 60 g of deionized water. The temperature fell to about 40° C. After 15 minutes of stirring the temperature was slowly raised to 75° C. Starting at about 45° C., an azeotrope of methyl ethyl ketone and water was distilled off. When most of the methyl ethyl ketone had been distilled off, distillation was continued under slightly reduced pressure (100 to 400 mbar) with an increase in the temperature. After the methyl ethyl ketone had all been removed, deionized water was added to set a mass fraction of solids (nonvolatile fraction) of 45%. The product was a fine, solvent-free dispersion having a viscosity (23° C., 25 s⁻¹) of 252 mPa·s.

### Example 3

302.3 g of polybutadiene diol (hydroxyl number 45 to 50 mg/g, ®PolyBD-R45 HTLO from Cray Valley), 9.2 g of triethylamine and 17.9 g of dimethylolpropionic acid were dissolved in 340 g of methyl ethyl ketone at from 75 to 80° C. When a clear, homogeneous solution had been obtained, 89.9 g of isophorone diisocyanate were added. The reactor was sealed and the batch was stirred until the Staudinger index (“intrinsic viscosity number”) had reached a figure of between 22 and 23 cm³/g. The internal pressure of the reactor rose to about 0.4 bar above the external pressure. When this Staudinger index had been reached, 35.5 g of polycarbonate diol (®Ravecarb 107, Enichem) were added and the components were stirred together for 15 minutes. This mixture was dispersed with 579 g of deionized water and immediately thereafter was chain-extended with a solution of 6.8 g of ethylenediamine in 60 g of deionized water. The temperature fell to about 40° C. After 15 minutes of stirring the temperature was slowly raised to 75° C. Starting at about 45° C., an azeotrope of methyl ethyl ketone and water was distilled off. When most of the methyl ethyl ketone had been distilled off, distillation was continued under a slightly reduced pressure (100 to 400 mbar) with an increase in the temperature. After the methyl ethyl ketone had all been removed, deionized water was added to set a mass fraction of solids (nonvolatile fraction) of 45%. The product was a fine, solvent-free dispersion having a viscosity (23° C., 25 s⁻¹) of 720 mPa·s.

### Example 4

### Soft-Feel Paints

In accordance with the indications in the table, paints were prepared by mixing the composition referred to as part 1 in a dissolver and milling it for 30 minutes on a bead mill. The mixture obtained was freed from the foam and mixed with the crosslinker, which is referred to as part 2, immediately prior to application.

The tactile properties of the coating produced can be adjusted in a targeted way through the choice of the proportion between polycarbonate diol and polybutadiene diol.

TABLE
Paint composition

| | Paint | 4.1 | 4.2 | 4.3 |
|---|---|---|---|---|
| Part 1 | Coating composition from example | 1 | 2 | 3 |
| | Mass of the PU dispersion | 56.72 | 57.24 | 49.3 |
| | Flatting agent¹ | 6.11 | 4.88 | 5.05 |
| | Flatting agent² | 0.12 | 1.12 | 0.04 |
| | Carbon black paste³ | 3.2 | 3.2 | 3.2 |
| | Defoamer⁴ | 0.83 | 0.83 | 0.74 |
| | Wetting agent⁵ | 0.83 | 0.83 | 0.74 |
| | Rheological additive⁶ | 0.4 | 0.4 | 0.4 |
| | Methoxypropanol | 1.21 | 0.29 | 1.25 |
| | N-Methylpyrrolidone | 0.25 | 0.08 | 0.11 |
| | Deionized water | 23.01 | 22.86 | 31.97 |
| Part 2 | ® Desmodur N 3100⁷ | 5.53 | 0.54 | 3.05 |
| | ® Desmodur N 3300⁸ | 1.79 | | |
| | ® Desmodur N 2306⁹ | | 7.73 | 4.15 |
| | Mass fraction of solids in % | 43.5 | 44.5 | 38.4 |
| | Solvent content in % | 1.46 | 0.37 | 1.36 |
| | Flow time 4 mm cup in s | 48 | 50 | 40 |
| | Flash point DIN EN 22719 in ° C. | incombustible | | |
| | Drying | flashing off at room | | |
| | | temperature, forced | | |
| | | drying 80° C., 30 min | | |
| | Tactile properties | rubber- | between | wax- |
| | | like | rubber- | like |
| | | | like | |
| | | | and | |
| | | | waxlike | |

Key:
¹pyrogenic silica, ®Degussa TS 100
²polyamide powder ® Orgasol 2001 UDNAT2
³®Colanyl black PR 130, Clariant GmbH
⁴defoamer based on mineral oil/silica
⁵wetting additive ® Byk 346
⁶flow improver ® Additol VXW 6200
⁷hexamethylene diisocyanate trimer, hydrophilic, Bayer AG
⁸hexamethylene diisocyanate trimer, Bayer AG
⁹aliphatic polyfunctional isocyanate, Bayer AG

What is claimed is:

1. An aqueous coating composition comprising polycarbonate polyols A2 and a polyurethane chain-extended with compounds D which are at least difunctional with respect to isocyanates, said polyurethane comprising building blocks of hydroxy acids C and urethane groups derived from polyfunctional isocyanates B and said polyurethane containing blocks derived from polyene polyols A1 and from polycarbonate polyols A2.

2. The aqueous coating composition as claimed in claim 1, wherein the mass ratio of blocks derived from polyene polyols A1 to blocks derived from polycarbonate polyols A2 is from 1:8 to 4:5.

3. The aqueous coating composition as claimed in claim 1, whose acid number is at least 15 mg/g.

4. The aqueous coating composition as claimed in claim 1, wherein the isocyanates B are aliphatic linear, branched or cyclic isocyanates.

5. The aqueous coating composition as claimed in claim 1, wherein the ratio of the amount of substance of the isocyanate-reactive groups of the chain extenders D to the amount of substance of the isocyanate groups in the isocyanate-functional prepolymers is from 0.5:1 to 1:1.

6. A process for preparing an aqueous coating composition as claimed in claim 1, which comprises in the first step a) preparing an isocyanate-functional prepolymer from the polyene polyols A1, the hydroxy acids C, and the polyfunctional isocyanates B and in the second step b) mixing said prepolymer with the polycarbonate polyol A2 and, after an at least partial reaction, in the third step c) dispersing this mixture with water containing a chain extender D.

7. The process as claimed in claim 6, wherein, in the reaction in step c), from 1 to 20% of the polycarbonate polyol A2 reacts with the isocyanate-functional prepolymer to form an adduct.

8. The process as claimed in claim 6, wherein the isocyanate-functional prepolymer prepared in step a) has a Staudinger index of at least 18 cm³/g.

9. A method of use of an aqueous coating composition as claimed in claim 1 to produce soft coatings, comprising coating substrates selected from metal, plastic, wood, stone, and concrete with the coating composition as claimed in claim 1 and an isocyanato-containing crosslinking agent.

10. A substrate coated with an aqueous coating composition as claimed in claim 1.
